(19) United States
(12) Patent Application Publication
(10) Pub. No.: US 2025/0077859 A1
(43) Pub. Date: Mar. 6, 2025

(54) VIDEO RETRIEVAL BASED CONTEXTUALIZED LEARNING

(71) Applicant: Cisco Technology, Inc., San Jose, CA (US)

(72) Inventors: Pengfei Sun, Reno, NV (US); Qihong Shao, Clyde Hill, WA (US)

(21) Appl. No.: 18/461,168

(22) Filed: Sep. 5, 2023

(51) Int. Cl. G06N 3/08; G06N 3/0455

(52) U.S. Cl. CPC G06N 3/08; G06N 3/0455

(57) ABSTRACT

Methods are provided for generating distilled multimedia data sets tailored to user's persona and/or task(s) to be performed associated with an enterprise network and enable interactive contextual learning using a multi-modal knowledge graph. Methods involve obtaining multimedia data from one or more data sources related to operation or configuration of an enterprise network and determining context for generating a distilled multimedia data set based on at least one of user input and user persona. The methods further involve generating, based on the context, the distilled multimedia data set that includes a set of multimedia slices generated from the multimedia data using a multi-modal knowledge graph. The multi-modal knowledge graph is generated using a graph neural network and indicates relationships among a plurality of slices of the multimedia data. The methods further involve providing the distilled multimedia data set for performing one or more actions associated with the enterprise network.

### TECHNICAL FIELD

The present disclosure generally relates to multimedia processing and network systems.

### BACKGROUND

Enterprise networks include many assets and involve various enterprise service functions for equipment and software. Enterprise networks are often managed by a team of information technology (IT) specialists. This is particularly the case for enterprises that have large networks or systems of numerous instances and types of equipment and software. Tracking performance, troubleshooting, and integrating new technology and/or updates for networking or equipment and software in large enterprise networks is time consuming and often involves reviewing numerous videos, seminar recordings, and/or tutorials.

### BRIEF DESCRIPTION OF THE DRAWINGS

FIG. 1 is a block diagram of a system that includes a graph based semantic contextualization service that interacts with an enterprise service cloud portal and network/computing equipment and software residing at various enterprise sites of an enterprise network domain, according to an example embodiment.

FIG. 2 is a diagram illustrating components of a graph based semantic contextualization service that generates a distilled video from multimedia data obtained from various data sources, according to an example embodiment.

FIG. 3 is a diagram illustrating an environment in which an e-learning graph generator generates a multimedia graph of multimedia data, according to an example embodiment.

FIG. 4 is a diagram illustrating an environment in which the e-learning graph generator performs rectification of the multimedia graph, according to an example embodiment.

FIG. 5 is a diagram illustrating an environment in which a contextualization component generates a knowledge graph specifically tailored to user persona and/or context, according to an example embodiment.

FIG. 6 is a diagram illustrating an environment in which an interactive learning component retrieves one or more recommended multimedia data sets based on context, according to an example embodiment.

FIG. 7 is a diagram illustrating an environment in which an interactive learning component generates a distilled multimedia data set based on a search query, according to an example embodiment.

FIG. 8 is a diagram illustrating an environment in which an interactive learning component generates a distilled multimedia data set based on multiple search queries, according to an example embodiment.

FIG. 9 is a flowchart illustrating a method of providing a distilled multimedia data set for performing one or more actions associated with an enterprise network, according to an example embodiment.

FIG. 10 is a hardware block diagram of a computing device that may perform functions associated with any combination of operations in connection with the techniques depicted and described in FIGS. 1-9, according to various example embodiments.

### DETAILED DESCRIPTION OF EXAMPLE EMBODIMENTS

### Overview

Techniques presented herein provide a graph based semantic contextualization service that generates distilled multimedia data sets of multimedia slices that are tailored to user's persona and/or specific to task(s) to be performed with respect to an enterprise network and enable interactive contextual learning using a multi-modal knowledge graph.

In one form, computer-implemented methods involve obtaining multimedia data from one or more data sources related to operation or configuration of an enterprise network and determining context for generating a distilled multimedia data set based on at least one of user input and user persona. The computer-implemented methods further involve generating, based on the context, the distilled multimedia data set that includes a set of multimedia slices generated from the multimedia data using a multi-modal knowledge graph. The multi-modal knowledge graph is generated using a graph neural network and indicates relationships among a plurality of slices of the multimedia data. The computer-implemented methods further involve providing the distilled multimedia data set for performing one or more actions associated with the enterprise network.

### EXAMPLE EMBODIMENTS

In the network field, users are sometimes overwhelmed by a large amount of domain knowledge provided via tutorial and/or seminar recordings i.e., multimedia data. The multimedia data includes an audio portion and/or a video portion that assist users in task completions. Some non-limiting examples of multimedia data include video deep dive tutorials for lifecycle enterprise network assets maintenance and management, video learning seminars for configuring one or more network devices in the enterprise network and/or performing actionable tasks with respect to the enterprise network, video network operations related tutorials for obtaining operating data of network devices in the enterprise network (e.g., how to configure and gather telemetry data), video technology integration tutorials for progressing a network technology along an adoption lifecycle, and/or troubleshooting related video recordings that address one or more network issues and how to perform remediating actions on affected network devices such as changing a configuration of one or more affected network devices in the enterprise network.

Typically, network knowledge and insights from domain experts are not accessible through general open search or other resources in part because of the complexities associated with the network domain. Instead, users review related learning sessions i.e., multimedia data, to find information about which actions to performs and/or how to complete task(s) in the network domain. This manual process is tedious and time consuming.

Efficiency of the manual process is low because users review many domain specific learning resources (videos/tutorials/seminar recordings) to gather relevant information for performing one or more actions associated with the enterprise network and/or for completing task(s) associated with an enterprise network. Users distill domain knowledge and the “know how” among piles of multimedia data.

Additionally, existing electronic learning (e-learning) systems provide multimedia data sets (e.g., tutorial recordings and learning session recordings) to users based on presumed context. That is, users passively receive information from a multimedia data set e.g., a batch of videos about fixing a network issue. Existing e-learning systems adopt a passive learning approach and lack interactions with users that would provide additional videos beyond the preset scope of the video batch, for example. Moreover, learning session recordings are pre-wrapped into different multimedia data sets (e.g., a batch of videos) and are distributed to users without considering users' backgrounds and past experiences (e.g., skill level, expertise, network persona, etc.). These learning session recordings may be too basic for some users and too advanced for others.

Further, it is difficult to extract details or knowledge from multimedia data e.g., original videos, using traditional video retrieval systems. Traditional video retrieval systems are limited to forming a database of keywords for the videos and using these keywords to retrieve these videos. Traditional video retrieval systems may use image feature extraction and/or audio features to generate keywords for the videos. Context transcriptions may then be used for temporal localization e.g., for a video frame search. However, these traditional video retrieval systems are designed for isolated video on either summarization/caption or image frame localization. In other words, these traditional video retrieval systems cannot generate contents from multiple video sources, address latent correlations among these videos, or customize these videos for the user.

On the other hand, techniques presented herein provide for extracting segments or slices from the multimedia data based on context specific to a user. A slice is a segment of multimedia data e.g., one or more video frames. A slice includes an audio portion and a video portion. A slice may further include a text portion of the corresponding audio portion. Multimedia data slices vary in length because they are formed based on semantic meaning/latent correlations i.e., events and entities. By way of an example, a first slice may be a five seconds long video segment, a second slice may be a ten seconds long video segment, and a third slice may be a two seconds long video segment. The slices are stitched together to form a distilled multimedia data set e.g., a distilled video. The distilled multimedia data set (distilled video) may benefit the problem-solving oriented hands-on session and may also provide for a quick and efficient learning that is customized to the user. Therefore, users may employ a “skip-viewing approach” for multimedia data such as a skip-reading approach for text-based learning materials. For example, users with prior knowledge establish quick understanding based on highly specific video snippets i.e., multimedia data slices.

Domain-expert-oriented e-learning provides specialty skill sets that may be necessitated by highly demanded tasks in the network domain. Learning curves vary depending on the users' prior knowledge and skill sets. For example, a user with an operator user persona is familiar with network configurations and is prepared to fix network issues. Therefore, their distilled multimedia data set (learning sessions) is more problem-driven to accelerate the end-to-end solution. Comparatively, a user with a manager user persona may have more knowledge on an agile project monitoring and risk management while less experience with lifecycle maintenance and deployment of network technologies. Thus, their distilled multimedia data set (learning sessions) are more pipeline driven and may provide additional multimedia data slices to complete a deployment task.

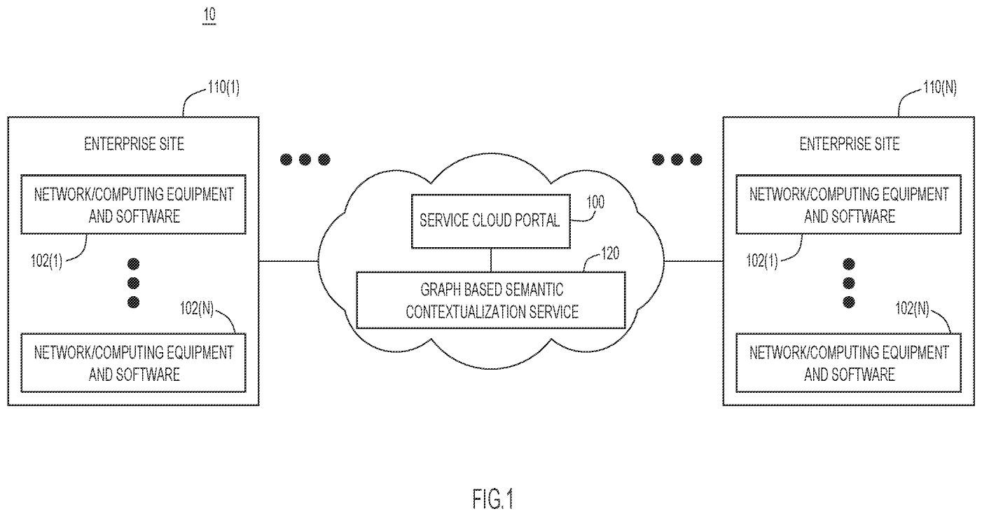

FIG. 1 is a block diagram of a system 10 that includes a graph based semantic contextualization service 120 that interacts with an enterprise service cloud portal (cloud portal) 100 and network/computing equipment and software 102(1)-102(N) residing at various enterprise sites 110(1)-110(N), or in cloud deployments of an enterprise, according to an example embodiment.

The notations 1, 2, 3, . . . n; a, b, c . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The system 10 is one example of an enterprise network. The system 10 may involve multiple enterprise networks. The network/computing equipment and software 102(1)-102(N) are resources or assets of an enterprise (the terms “assets” and “resources” are used interchangeably herein). The network/computing equipment and software 102(1)-102(N) may include any type of network devices or network nodes such as controllers, access points, gateways, switches, routers, hubs, bridges, gateways, modems, firewalls, intrusion protection devices/software, repeaters, servers, and so on. The network/computing equipment and software 102(1)-102(N) may further include endpoint or user devices such as a personal computer, laptop, tablet, and so on. The network/computing equipment and software 102(1)-102(N) may include virtual nodes such as virtual machines, containers, point of delivery (POD), and software such as system software (operating systems), firmware, security software such as firewalls, and other software products. The network/computing equipment and software 102(1)-102(N) may be in a form of software products that reside in an enterprise network and/or in one or more cloud(s). Associated with the network/computing equipment and software 102(1)-102(N) is configuration data representing various configurations, such as enabled and disabled features. The network/computing equipment and software 102(1)-102(N), located at the enterprise sites 110(1)-110(N), represent information technology (IT) environment of an enterprise.

The enterprise sites 110(1)-110(N) may be physical locations such as one or more data centers, facilities, or buildings located across geographic areas that designated to host the network/computing equipment and software 102(1)-102(N). The enterprise sites 110(1)-110 (N) may further include one or more virtual data centers, which are a pool or a collection of cloud-based infrastructure resources specifically designed for enterprise intents, and/or for cloud-based service provider intent. Each enterprise site is a network domain, according to one example embodiment.

The network/computing equipment and software 102(1)-102(N) may send to the cloud portal 100, via telemetry techniques, data about their operational status and configurations so that the cloud portal 100 is continuously updated about the operational status, configurations, software versions, etc. of each instance of the network/computing equipment and software 102(1)-102(N) of an enterprise.

The cloud portal 100 is driven by human and digital intelligence that serves as a one-stop destination for equipment and software of an enterprise to access insights and expertise and specific to a particular stage of an adoption lifecycle. Examples of capabilities include assets and coverage, cases (errors or issues to troubleshoot), automation workbench, insights with respect to various stages of an adoption lifecycle and action plans to progress to the next stage, etc. The cloud portal 100 helps the enterprise network technologies to progress along an adoption lifecycle based on adoption telemetry and enabled through contextual learning, support content, expert resources, and analytics and insights embedded in context of the enterprise's current/future guided adoption tasks. The cloud portal 100 may store multimedia data (multiple video recordings) collected from different data sources, such as video tutorial recordings, video learning seminars, debugging or troubleshooting videos, and/or other network related videos e.g., for progressing a network technology along an adoption lifecycle or changing the configuration of one or more affected network devices.

A network technology is a computing-based service or a solution that solves an enterprise network or a computing problem or addresses a particular enterprise computing task. The network technology may be offered by a service provider to address aspects of information technology (IT). Some non-limiting examples of a network technology include access policies, security and firewall protection services, software image management, endpoint or user device protection, network segmentation and configuration, software defined network (SDN) management, data storage services, data backup services, data restoration services, voice over internet (VOIP) services, managing traffic flows, analytics services, etc. Some network technology solutions apply to virtual technologies or resources provided in a cloud or one or more data centers. The network technology solution implements a particular enterprise outcome and is often deployed on one or more of the network/computing equipment and software 102(1)-102(N).

An adoption of network technology solution refers to enterprise's uptake and utilization of a network technology for achieving a desired outcome. A journey refers to end-to-end activities performed by an enterprise when adopting a network technology including tasks they perform and defined stages to progress. An adoption lifecycle refers to a step-by-step guidance along the adoption journey to accelerate the speed to value of a network technology. The adoption lifecycle may encompass the end-to-end journey stages of: need, evaluate, select, align, purchase, onboard, implement, use, engage, adopt, optimize, recommend, advocate, accelerate, upgrade, renew, etc.

As noted above, various IT specialists (users) interact with the cloud portal 100 to manage network devices and software of the enterprise. There are many factors for a user to consider when building, operating, and maintaining enterprise network(s) and/or data center(s).

For example, an enterprise network may include dispersed and redundant sites such as the enterprise sites 110(1)-110(N) to support highly available services (e.g., network at various geographic locations). These enterprise sites 110(1)-110(N) include network/computing equipment and software 102(1)-102(N), which may be different hardware and software that host network services may be used for the enterprise services (e.g., product families, asset groups). Different types of equipment run different features and configurations to enable the enterprise services.

Moreover, each device or group of devices may encounter various issues. In one example embodiment, these issues involve network related problems or potential problems. Network related problems may involve an outage, a latency problem, a connectivity problem, a malfunction of the network device or software thereon, and/or incompatibility or configuration related problems. In one example embodiment, issues may involve defects, obsolescence, configurations, workarounds, network patches, network information, etc. Issues may relate to warranties, licenses, or may be informational notices e.g., for a particular configuration or upgrade.

Because of the complexities of the network domain, network domain knowledge for building, operating, and maintaining enterprise network(s) and/or data center(s) (including resolving network related problems and issues) is often in a form of multimedia data (e.g., a video tutorial, a seminar recording, etc.). Multimedia data may be helpful in educating and/or guiding users to perform various actions associated with the enterprise network e.g., complicated network tasks that involve multiple actions and/or enterprise assets (troubleshooting videos for mitigating a network issue on affected devices).

While example embodiments relate to network-related multimedia data, the disclosure is not limited thereto and may be applied to other domains e.g., technology related domains. The techniques presented herein learn user's role within a target domain and the target task to generate the distilled multimedia data set specific to the user's role and context based on learned semantic meanings in the target domain.

In one example embodiment, the graph based semantic contextualization service 120 generates a distilled multimedia data set so that a user may use the “skip-viewing approach” for multimedia data similar to the skip-reading approach for text-based learning materials. For example, providing experienced users with highly specific video snippets i.e., multimedia data slices, in the distilled multimedia data set, while providing novice users with more detailed video snippets in the distilled multimedia data set. Further, multimedia data slices that do not directly relate to a task to be performed in the enterprise network are omitted from the distilled multimedia data set. The distilled multimedia data set includes a plurality of slices carefully selected by the graph based semantic contextualization service 120 based on user's context (i.e., user persona, action(s) to be performed in the enterprise network, user's input). Each slice has an audio portion and one or more video frames. The selected slices are stitched together to generate a contextualized and highly customized distilled multimedia data set (e.g., a custom video).

User persona is user's identity or network persona within an enterprise network and includes user's role(s) within the enterprise network i.e., tasks or activities that the user is to perform for the enterprise network. The user persona may be determined based on a user profile within each enterprise network and/or user's click-through history (activities of the user within each enterprise network). U.S. application Ser. No. 17/973,121, titled “PERSONAS DETECTION AND TASK RECOMMENDATION SYSTEM IN NETWORK”, filed Oct. 25, 2022, provides some examples of the techniques that may be used for determining a user persona i.e., network persona of a user.

By way of a non-limiting example, a user persona may be a protector, an operator, a decider, a researcher, a planner, or a developer. The operator may focus on asset management such as status and performance of the network equipment and software 102(1)-102(N), whereas the planner may focus on an overall performance of the enterprise network (whether the enterprise has enough resources/assets to serve the operations, etc.).

User persona may further be based on different daily tasks performed by the user depending on the type, size, and job segmentation of their enterprise. For example, the operator may have a network role that focuses on hardware assets of the enterprise or may have a security role that focuses on operating system versions of the enterprise assets. The user persona may thus account for different jobs performed by the user. The user persona may further be different for different enterprises. For example, the planner may focus on enterprise network's reliability and stability for enterprise A while focusing on increasing the present network workload for enterprise B. The user persona may account for different tasks performed by the user for different enterprises.

Moreover, the user persona may further include skill level of the user. A user with the same role may have a different level of expertise or experience. For example, a network operator with ten years of experience and long activity history with the enterprise network has a different user persona than a network operator that is working less than year with the enterprise network and has a short activity history.

Based on different user personas, the graph based semantic contextualization service 120 generates different distilled multimedia data sets that are individually tailored to the user (i.e., user persona and context). By using the user persona and prior to contextualizing the multimedia data (e.g., numerous video sessions from different data sources), the distilled multimedia data sets are tailored to satisfy conditions for specific tasks targeting on a certain user role. The distilled multimedia data sets save time for users and provide a more efficient and targeted way to solve a network problem and/or learn a particular task.

In addition, the graph based semantic contextualization service 120 wraps latent semantic context of the multimedia data into a semantic graph, thus allowing for an interactive learning approach. The graph based semantic contextualization service 120 leverages an interactive approach for obtaining user input i.e., user inputs context for generating the distilled multimedia data set. The users may apply a question and answer model or a few-shot prompting to a multimedia knowledge base using text subgraphs. The graph formalized multimedia data further facilitates interactive learning by plugging into a generative search engine, for example, so that users can directly find learning video sessions for their task(s).

The graph based semantic contextualization service 120 leverages a multi-modal knowledge graph on video retrievals to enable contextualized interactive learning. The prompt based concept and graph neural networks are employed to improve and expedite users' learning and experiences. For example, a text-audio-video aligned e-learning graph (i.e., multimedia graph) allows the graph based semantic contextualization service 120 to exploit each user's interests and find video segments (select multimedia slices) for more efficient e-learning in the network domain.

The graph based semantic contextualization service 120 enables graph-based video-text modality for knowledge distillation. The graph based semantic contextualization service 120 provides interactive learning through generative graph search to capture multimedia data sets (e.g., video sessions) and generate a comprehensive combined solution-driven multimedia data set (i.e., the distilled multimedia data set). Further, the graph based semantic contextualization service 120 provides an efficient video-text retrieval mechanism that uses automatic speech recognition (ASR), image summarization, and graph learning model, jointly.

In one example embodiment, the distilled multimedia data set may teach a user to perform one or more actionable tasks associated with configuring or managing the enterprise network. Each task may include one or more operations/actions. At least some of the actions may be performed by the cloud portal 100 such as changing a configuration of a particular network device(s), updating software asset(s) to a newer version, etc. The user is then notified that these automated actions were performed. The graph based semantic contextualization service 120 may generate a distilled video (using selected slices of different videos from different data sources) for performing the same action(s) on a group of devices (e.g. that run a particular service of the enterprise or use a particular network technology) such as automatically installing the same security patch for a first network/computing equipment and software 102(1) and a second network/computing equipment 102(N), where the first network/computing equipment and software 102(1) and the second network/computing equipment and software 102(N) are similarly functioning devices located at different enterprise sites.

While one or more example embodiments describe the distilled multimedia data set for performing one or more actions associated with the enterprise network using the cloud portal 100, this is just an example. Actionable tasks may involve other services and/or systems. Actionable tasks may or may not involve the cloud portal 100.

In one example embodiment, actionable tasks may include a first action that involves a network management platform for a first enterprise site 110(1) and a second action that involves a network controller of the network domain, and a third action that involves a direct connection to one of the network/computing equipment and software 102(1)-(N) at a second enterprise site 110(N). Actionable tasks may include actions that are performed in multiple management platforms and the like. The distilled multimedia data set may be a combination of selected video slices stitched together about the first action from a first video recording, the second action from a second video recording, and the third action from a third video recording, which are obtained from different sources from one another.

In one or more example embodiments, the graph based semantic contextualization service 120 may be part of or be associated with a video retrieval system (e.g., internal video retrieval system for enterprise IT resources or troubleshooting) and/or an e-learning system (e.g., an IT certification related e-learning system). The graph based semantic contextualization service 120 may be applied to various multimedia data including audio recordings, and/or video recordings, etc.

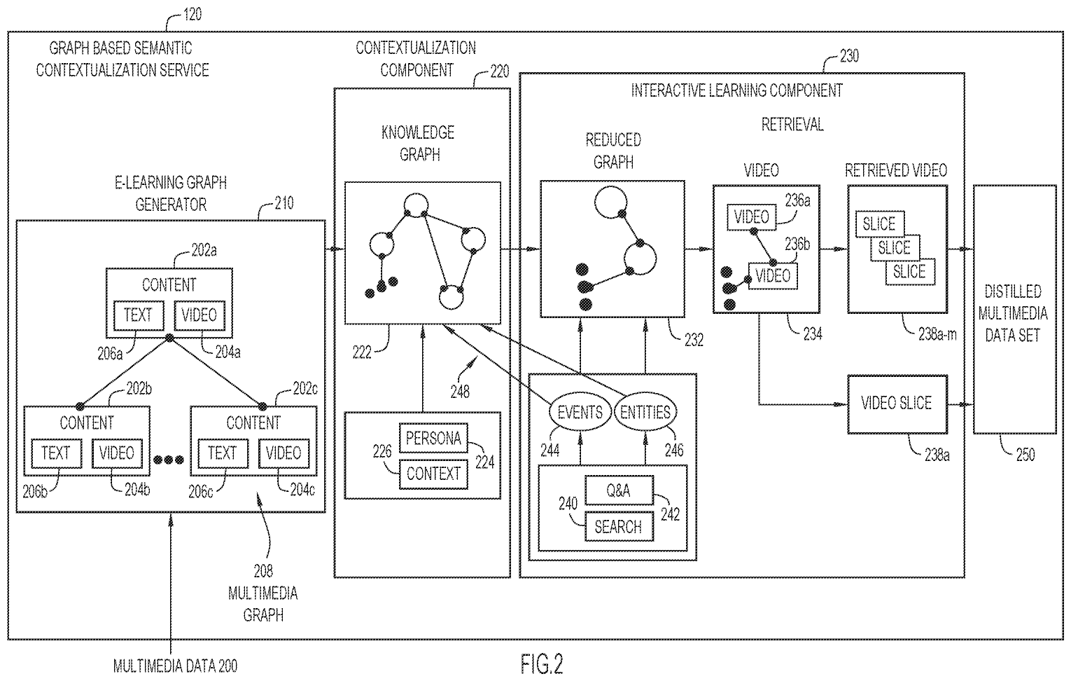

With continued reference to FIG. 1, FIG. 2 is a block diagram illustrating components of the graph based semantic contextualization service 120 of FIG. 1 that generates a distilled multimedia data set 250 using multimedia data 200 from one or more different data sources, according to an example embodiment. The graph based semantic contextualization service 120 includes an e-learning graph generator 210, a contextualization component 220, and an interactive learning component 230.

The e-learning graph generator 210 may obtain multimedia data 200 from different data sources via network(s) such as the Internet. For example, the multimedia data 200 may include video seminar recordings from an online library, a plurality of video tutorials from a product manufacturer's database and/or community forums, expert webinar recordings from another online library, accelerator one-on-one coaching session recordings from an enterprise knowledge base, a plurality of expert webinar video recordings from a content management platform, and/or a plurality of fixit video recordings from an advisory information systems database.

The e-learning graph generator 210 semantically analyzes the multimedia data 200 and segments it into various portions i.e., content 202a-c such as a first content 202a, a second content 202b, and a third content 202c. Each of the content 202a-c includes a video portion and an audio portion attached as attributes to a text portion. For example, the first content 202a includes a first video portion (first video 204a) and a first audio/text portion (text 206a), the second content 202b includes a second video portion (second video 204b) and a second audio/text portion (text 206b), and the third content 202c includes a third video portion (third video 204c) and a third audio/text portion (text 206c). Each of the content 202a-c is a snippet, a segment, or a slice of a video recording e.g., a predetermined number of video frames with corresponding audio and text. The e-learning graph generator 210 extracts text transcripts from audios attached to the video data and then generates a multimedia graph 208 to semantically connect the content (various multimedia portions) across different knowledge domains. Each of the content 202a-c is represented by a node on the multimedia graph 208 and is semantically linked to one or more other nodes based on events and entities in the text.

The contextualization component 220 obtains the multimedia graph 208 and generates a knowledge graph 222 based on user persona 224 and/or context 226. The user persona 224 may be based on user's past activity and may include experience level or skill level of the user. The context 226 may be any other relevant information e.g., enterprise context, user's context, target tasks. In one example embodiment, context 226 may be determined from user's past activities and/or input that indicates user's intent. For example, the context 226 may be “configuration information of switch A, network assets managed by the user, enterprise asset portfolio, an agile certification process, etc. The contextualization component 220 generates the knowledge graph 222 using graph neural networks and contextual embedding of user persona 224 and/or context 226. The knowledge graph 222 is based on text of the multi-modal graph and indicates latent relationships among various nodes (content 202a-c) specifically tailored to the user and/or the target task (the user persona 224 and/or the context 226).

The interactive learning component 230 generates a distilled multimedia data set 250. The interactive learning component 230 uses the knowledge graph 222 to generate sub-graphs e.g., a reduced graph 232 that is specifically tailored to completing target task(s) i.e., performing one or more actions associated with an enterprise network.

In one example embodiment, the interactive learning component 230 retrieves video 234 (e.g., multimedia data sets such as a first video 236a and a second video 236b) that may be relevant to a user based on the reduced graph 232. For each of the retrieved multimedia data set, the interactive learning component 230 extracts slices 238a-m that are relevant to the user, determined using the reduced graph 232. For example, from the second video 236b, only a first video slice 238a is extracted/selected. The interactive learning component 230 stiches together the slices 238a-m to generate the distilled multimedia data set 250. The distilled multimedia data set 250 includes multiple video snippets that are tailored to the user persona 224 and the context 226 (e.g., target task).

In another example embodiment, the interactive learning component 230 generates the distilled multimedia data set 250 based on user input i.e., meta interactive learning. Specifically, the interactive learning component 230 obtains user input such as a search query (search 240). The interactive learning component 230 utilizes graph learning to generate contextualized subgraph i.e., the reduced graph 232, which is further used to accurately locate the video clips i.e., slices 238a-m. The interactive learning component 230 leverages graph learning to generate the desired subgraph(s) based on users' input. The user's input may involve multiple search queries in a form of question and answer (Q&A 242). The Q&A 242 may involve a prompt engine that obtains multiple user inputs (e.g., software update A and network devices with a bug B). The Q & A 242 may involve generative pre-trained transformers that converse with the user to focus the scope of the video search. The interactive learning component 230 generates event embeddings (events 244) and entities embeddings (entities 246), which are then used to generate subgraphs i.e., the reduced graph 232. Moreover, as shown at 248, the events 244 and entities 246 are fed back into the knowledge graph 222 to improve latent relationships and semantic meanings therein.

The graph based semantic contextualization service 120 thus provides a graph based semantic contextualization to refine video knowledge retrieval and/or video searching. The curation of the video materials collects the most correlated knowledge excerpts based on the user persona 224, context 226, and/or user input (e.g., search 240, Q&A 242 such as chat-type search queries). The graph based semantic contextualization service 120 generates distilled multimedia data set 250 i.e., a video distillation that captures key video frames that satisfy user's intent to complete network related task(s) and that excludes redundancy and unnecessary knowledge.

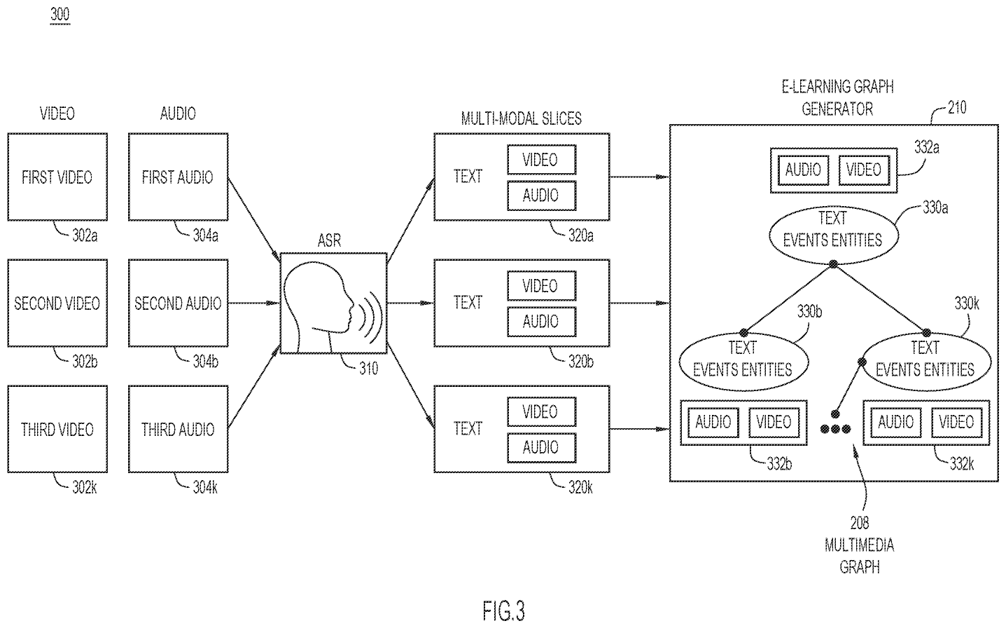

With continued reference to FIGS. 1 and 2, FIG. 3 is a diagram illustrating an environment 300 in which an e-learning graph generator 210 generates a multimedia graph 208 of multimedia data, according to an example embodiment.

The environment 300 involves a plurality of videos 302a-k such as a first video 302a, a second video 302b, and a third video 302k. The environment 300 further involves an auto speech recognition component or text to speech converter (ASR 310) that converts an audio portion of each video (a first audio 304a, a second audio 304b, and a third audio 304k) into text, which is attached to respective videos to generate multi-modal slices 320a-k such as a first slice 320a, a second slice 320b, and a third slice 320k. The environment 300 further involves e-learning graph generator 210 that uses machine learning to generate the multimedia graph 208 based on the multimodal slices 320a-k.

In the environment 300, large amounts of learning sessions (plurality of videos 302a-k) are presented in a multimedia format (video format). The ASR 310 running on a video platform or an ASR application programming interface (API) converts audio portions 304a-k to text to generate text transcripts from the audio data attached to the learning sessions. In this generation phase, the ASR 310 translates or converts the audios derived from the videos into text.

The e-learning graph generator 210 semantically analyzes the text using machine learning to generate the multi-modal slices 320a-k. The e-learning graph generator 210 employs various language models to transform text into knowledge graphs i.e., the multimedia graph 208.

Specifically, by transcribing the audio portions 304a-k, the e-learning graph generator 210 further decomposes the generated text into events and entities using various language models such as recurrent neural networks, generative pre-trained transformers (GPT), bidirectional encoder representations from transformers (BERT), text-to-text transfer transformers (T5), etc. The e-learning graph generator 210 uses the decomposed event and entities to semantically segment the multimedia data e.g., the videos 302a-k, into multi-modal slices 320a-k. The generated text is transformed into a knowledge graph connected through the events (actions) and entities (subjects).

The multimedia graph 208 is established on top of the semantic knowledge base (e.g., the entities, events, and text). The audios/videos are attached as the attributes on the multimedia graph 208. For example, the multimedia graph 208 includes a first node 330a that corresponds to the first slice 320a and has a first audio/video portion 332a attached thereto, a second node 330b that corresponds to second slice 320b and has a second audio/video portion 332b attached thereto, and a third node 330k that corresponds to the third slice 320k and has a third audio/video portion 332k attached thereto. Events and entities from the text indicate latent correlations or relationships between the nodes 330a-k. In one example embodiment, time warping is used to accurately map the entities and events in the text back to the video/audio portions 332a-k, which in the training phase are further used as the prediction label to segment the videos 302a-k.

Based on the events and entities set, the knowledge-base-driven video-audio-text graph (i.e., the multimedia graph 208) is generated. The multimedia graph 208 is then used in the next phase either for video retrieval and/or interactive learning/searches.

With continued reference to FIGS. 1-3, FIG. 4 is a diagram illustrating an environment 400 in which the e-learning graph generator 210 performs rectification of the multimedia graph 208, according to an example embodiment. In a rectification phase, the e-learning graph generator 210 improves accuracy of text′ 410 obtained from audio 430 to generate text 420 and uses split events and entities in the text 420 to locate the video clips 442a-b and thus retrieve semantic information as feedback to update the multimedia graph 208.

Considering transcriptions may include spelling mistakes and other errors due to limitations on the accuracy of the ASR 310, the e-learning graph generator 210 performs rectification of the text′ 410. Specifically, at 412, the e-learning graph generator 210 updates the text′ 410 into text 420, which includes corrected spelling, etc. for the event and entity. That is, the e-learning graph generator 210 leverages a graph rectification module to exclude artifacts with errors from the ground truth.

The e-learning graph generator 210 then uses time-warping to accurately map the entities and events back to the audio 430 (audio portion). By utilizing the text-to-audio mapping, audios are aligned to the decomposed events and entities, shown at 432. Moreover, the aligned video segments are then applied to video 440, the segmented video clips 442a-b directly correspond to the event and entity in the text 420 i.e., first video clip 442a and second video clip 442b, shown at 444.

In one example embodiment, video frames may include more detailed knowledge such as semantic structures of the event and entity in the text 420. For example, image recognition/classification techniques are employed to directly extract text 420 from the video clips 442a-b. For example, a video seminar may include a presentation and a screen sharing. Text information in the presentation or slides may not be fully appreciated in the audio 430. The extracted text from the video clips 442a-b is then used as feedback to update the text 420. The e-learning graph generator 210 may thus combine the audio-based transcription and video-based text retrieval to generate a comprehensive knowledge space, in which the text 420 represents knowledge in the multimedia graph 208.

With continued reference to FIGS. 1 and 2, FIG. 5 is a diagram illustrating a contextualization component 220 generating a knowledge graph 222 specifically tailored to user persona 224 and/or context 226, according to an example embodiment. The contextualization component 220 obtains the multimedia graph 208, extracts text 502a-k therefrom, encodes the user persona 224 and/or the context 226 and applies a graph neural network 510 to generate the knowledge graph 222 having text nodes 520a-j such as a first node 520a, a second node 520b, a third node 520c, and a fourth node 520j.

The contextualization component 220 employs a personalized-context-driven video retrieval approach to deeply customize the multimedia data i.e., to tailor it specifically to the user and/or target task. Specifically, the contextualization component 220 employs the graph neural network 510 to learn the text 502a-k (events and entities such as first text 502a, second text 502b, and third text 502k) extracted from the multimedia graph 208.

Moreover, the user persona 224 and the context 226 are encoded into embeddings to contextualize the graph neural network learning. Specifically, the contextualization component 220 encodes the user persona 224 and the context 226 into a persona embedding and a context embedding, respectively. These embeddings are then input into the graph neural network 510 for contextualization. The learned representation (relationships) from the text 502a-k of the multimedia graph 208 conditioned on the user context (these embeddings) is then transformed into the knowledge graph 222 having text (events and entities) represented by text nodes 520a-j.

In one example embodiment, the context 226 may include prior enterprise settings (user enterprise profile), past activities of the user associated with the enterprise network including skill level, experience level, user's expertise, certifications, etc. The context 226 may further involve user's target task(s) (configuring switch type A) or studying for an advanced agile certification. As such, the knowledge graph 222 includes text nodes 520a-j (entities and events) and is specifically tailored to the user persona 224 and/or the context 226.

With continued reference to FIGS. 1-5, FIGS. 6-8 are diagrams illustrating the interactive learning component 230 retrieving relevant video slices to generate a distilled multimedia data set 250 and/or using user input (search query or queries) to provide interactive learning, according to example embodiments.

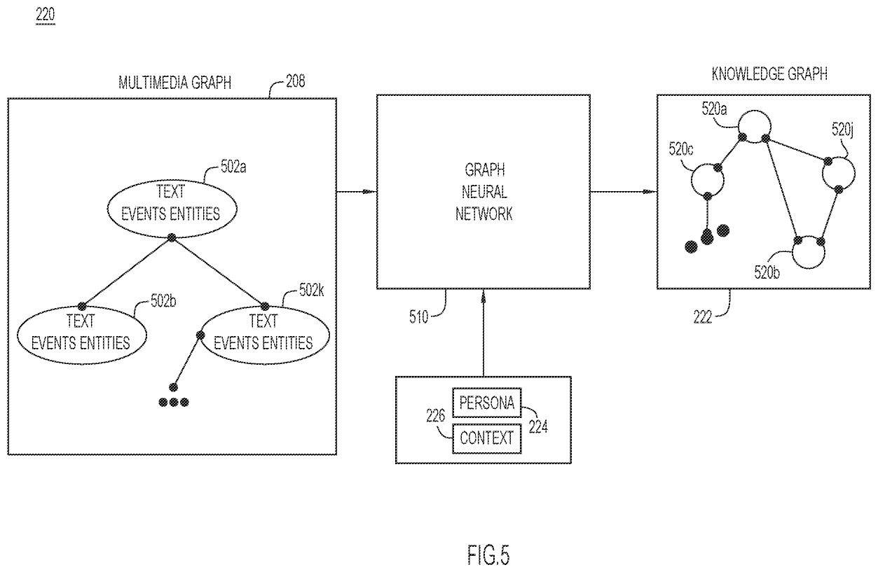

When the contextualization component 220 generates the knowledge graph 222 from the text in the multimedia graph 208 by incorporating the user persona 224 and/or context 226, the interactive learning component 230 may use other relevant information such as user's past activity, the enterprise context, network asset portfolio, network topology, etc. to generate reduced graphs or subgraphs i.e., the reduced graph 232, from the knowledge graph 222. The other relevant information is encoded into embeddings and is input into a graph neural network (e.g., the graph neural network 510 of FIG. 5) to generate the reduced graph 232. The reduced graph 232 includes text (entities and events), which are then applied to the multimedia graph 208 to obtain corresponding multimedia slices.

The reduced graph 232 provides additional contextualization by further reducing or narrows the learning scope of the user. For example, a user having an operator persona, may prefer technical details compared with the general license updating or other management resources. On the other hand, a user with an inventory covering a data center has a higher interest in network configuration knowledge than a user with a license management persona. The reduced graph 232 is then used for multimedia data retrieval and/or interactive learning.

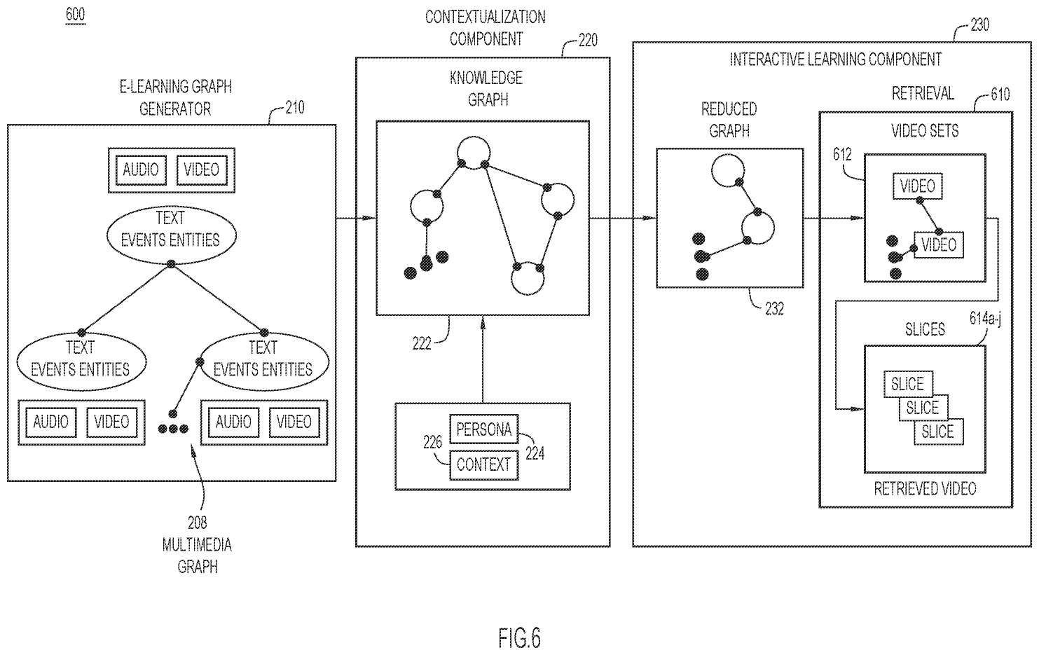

Specifically, FIG. 6 is a diagram illustrating an environment 600 in which the interactive learning component 230 retrieves one or more multimedia data sets to recommend to a user based on context, according to an example embodiment.

In the environment 600, the knowledge graph 222 represented by a graph neural network in general provides abstracting capability and the context from each user modulates the graph representation to generate a subgraph i.e., the reduced graph 232. Relatively, the reduced graph 232 excludes portions of the knowledge (i.e., nodes of the knowledge graph 222) that are irrelevant to the user's context. By feeding the user persona 224 and the context 226 (including user activity or target task) into a graph neural network, the interactive learning component 230 outputs the reduced graph 232 that is specifically tailored to the user and context.

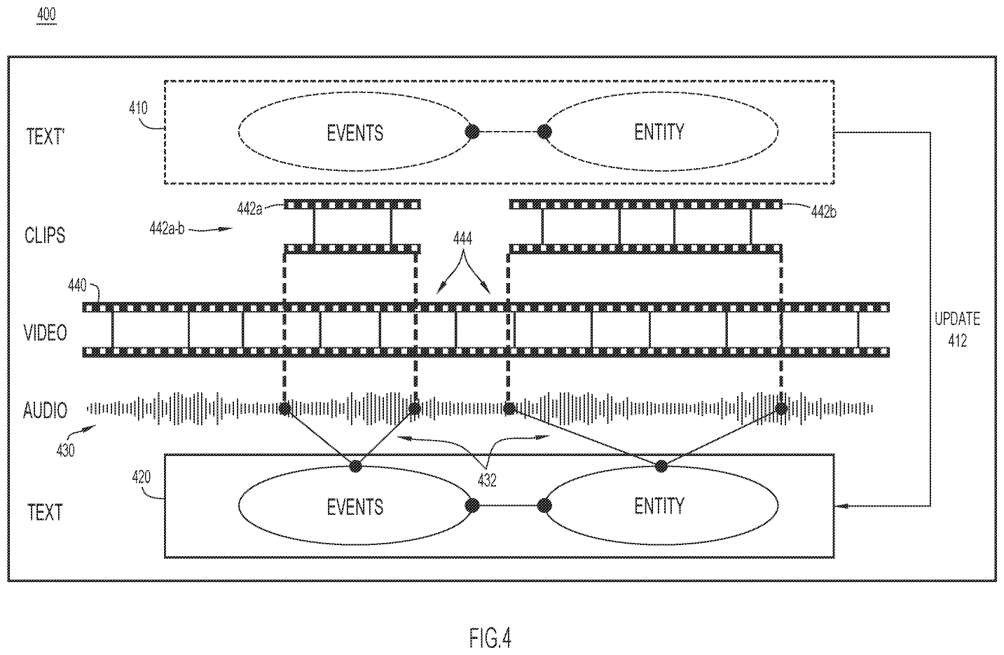

In the retrieval stage 610, the interactive learning component 230 applies the reduced graph 232 to the multimedia graph 208. Since the knowledge graph 222 is based on entities and events in the text, the corresponding audio segments are directly retrieved. Based on the predicted subgraph i.e., the reduced graph 232, the interactive learning component 230 maps the entities and events (text 420 of FIG. 4) back to the video sets 612 to find or locate the video clips or slices 614a-j that are most relevant for task completion for different users. The interactive learning component 230 automatically segments videos and contextualizes search for videos to generate recommendations for the user based on their prior knowledge (context 226) and user persona 224.

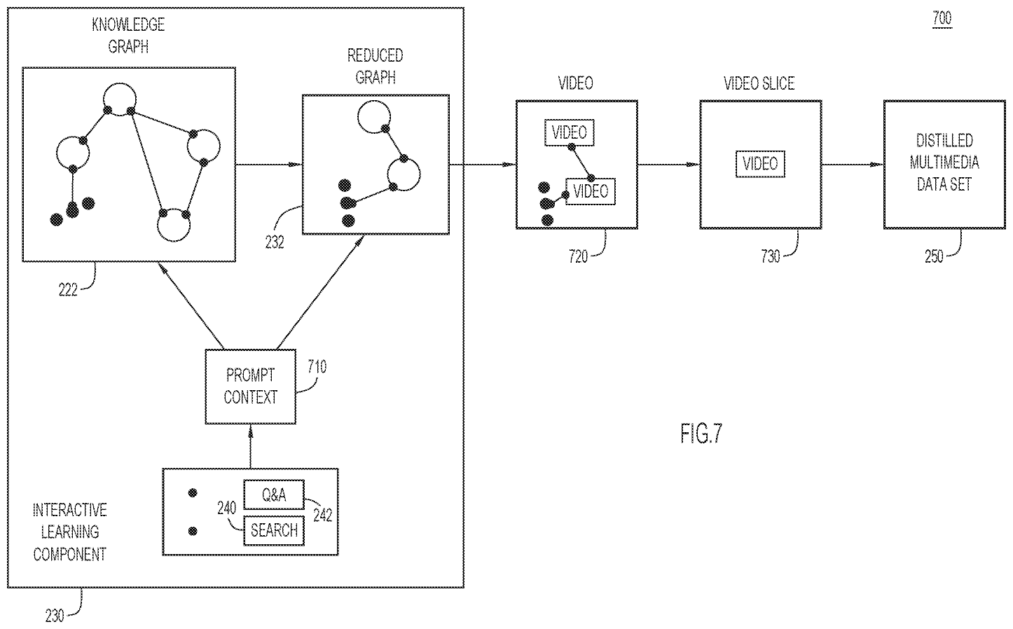

FIG. 7 is a diagram illustrating an environment 700 in which the interactive learning component 230 generates a distilled multimedia data set 250 based on a search query, according to an example embodiment. The environment 700 involves a prompt context 710 to generate the reduced graph 232 that is used to map back to video 720 and extract relevant video slices (video slice 730) therefrom.

Beyond automatically recommended learning sessions (videos) based on the user persona 224 and enterprise context (context 226) of FIG. 6, the interactive learning component 230 leverages user input in a form of the search 240 and/or the Q&A 242. For example, users submit their questions or input the search entities to address their specific concerns regarding various tasks. The user input is encoded into one or more input embedding to generate the prompt context 710, which is input into the knowledge graph 222 and/or the reduced graph 232 to capture context of the user's input. The reduced graph 232 is refined to reflect user input. The reduced graph 232 is then mapped back onto the multimedia graph 208 to retrieve video 720 and relevant video slices (video slice 730), which are stitched into the distilled multimedia data set 250.

Since the graph neural network 510 of FIG. 5 is generated by the contextualization component 220, as explained above, that represents the semantic knowledge, the interactive learning component 230 extends this graph learning model to capture the context from the inputs (the prompt context 710) and uses the prompt context 710 as inputs to predict the subgraphs to address users' interests.

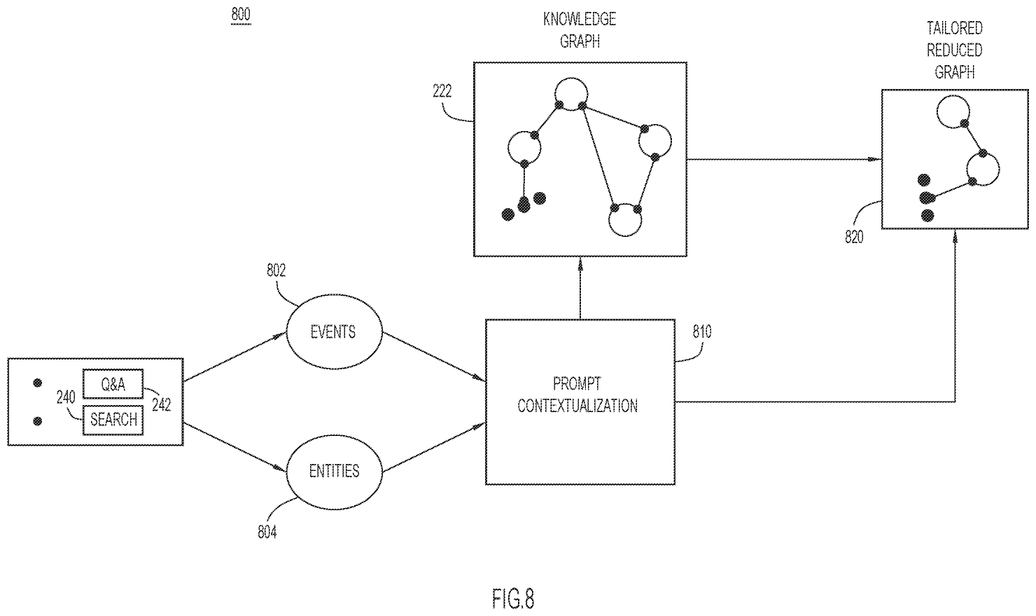

FIG. 8 is a diagram illustrating an environment 800 in which the interactive learning component 230 generates a distilled multimedia data set based on multiple search queries, according to an example embodiment. The environment 800 involves prompt contextualization 810 that extracts events 802 and entities 804 from user input (search 240 and Q&A 242) e.g., using a few-shot prompting, for example, to generate a tailored reduced graph 820 which may include a combination of various reduced graphs.

Specifically, the prompt contextualization 810 filters user inputs into a strengthened embedding based on events 802 and entities 804. The strengthened embedding is used to further explore the graph neural network (the knowledge graph 222) to generate variant subgraphs i.e., the tailored reduced graph 820. These variant subgraphs reflect different types of task-driven learning topics. By allowing users to input their own queries i.e., in a form of a conversation type such as ChatGPT, the graph neural network that represents the knowledge graph 222 may fully and flexibly capture the input context and may output various subgraphs i.e., the tailored reduced graph 820 to satisfy different user's target tasks.

Compared to the environment 700 of FIG. 7 in which the interactive learning component 230 directly converts user's context information as the graph learning model input, in the environment 800, the user directly inputs events 802 and entities 804 that are of interest. The distilled multimedia data set 250 is thus further tailored based on user input (multiple search queries-few shot prompting). The distilled multimedia data set 250 (e.g., customized e-learning video session) is considered as an interactive learning process on multiple tasks. The prompt contextualization 810 allows the knowledge graph 222 few-shot learning capability. The tailored reduced graph 820 is then used for video retrievals such as the retrievals of FIGS. 6 and 7.

The techniques presented herein leverage a multi-modal knowledge graph on video retrievals to enable contextualized interactive learning. The prompt context and graph neural networks are employed to improve users' experiences. Specifically, the text-audio-video aligned e-learning graph (multimedia graph) allows the graph based semantic contextualization service to exploit each user's interests and locate video segments (slices) for efficient e-learning in the network domain.

The techniques presented herein utilize multi-modal text-audio-video learning data to generate a knowledge graph (based on text in the multimedia graph) that is used retrieve video slices specifically tailored to user's context. Further, the semantic-level knowledge graph allows a lightweight and more efficient approach to retrieving relevant video clips or slices that are combined into a distilled multimedia data set. Additionally, prompt contextualization based on user inputs (multiple queries) allows a task-driven video retrieval and tailors the inputs to explore an interactive learning approach.

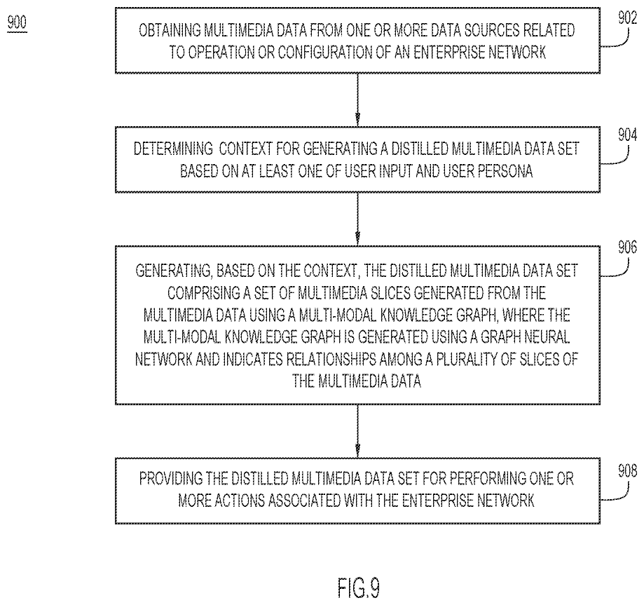

FIG. 9 is a flowchart illustrating a computer-implemented method 900 of providing a distilled multimedia data set for performing one or more actions associated with an enterprise network, according to an example embodiment. The computer-implemented method 900 may be performed by a computing device such as a server or a group of servers that execute the graph based semantic contextualization service 120 of FIGS. 1-8.

The computer-implemented method 900 involves, at 902, obtaining multimedia data from one or more data sources related to operation or configuration of an enterprise network.

The computer-implemented method 900 further involves at 904, determining context for generating a distilled multimedia data set based on at least one of user input and user persona.

The computer-implemented method 900 further involves at 906, generating, based on the context, the distilled multimedia data set comprising a set of multimedia slices generated from the multimedia data using a multi-modal knowledge graph. The multi-modal knowledge graph is generated using a graph neural network and indicates relationships among a plurality of slices of the multimedia data.

Additionally, the computer-implemented method 900 involves at 908, providing the distilled multimedia data set for performing one or more actions associated with the enterprise network.

According to one or more example embodiments, the user persona may be a network persona. The operation 906 of generating the distilled multimedia data set may include generating a reduced graph from the multi-modal knowledge graph based on the network persona and the user input and selecting at least two multimedia slices for the distilled multimedia data set using the reduced graph.

In one instance, the network persona may include a skill level of a user. The computer-implemented method 900 may further include determining the network persona based on past activities performed by the user with respect to the enterprise network.

In another instance, the user input may include an actionable task related to a configuration of the enterprise network. The computer-implemented method 900 may further involve encoding the user input to generate an input embedding and generating the reduced graph from the multi-modal knowledge graph based on the input embedding.

In one form, the computer-implemented method 900 may further include obtaining the user input including at least two search queries and encoding the user input to generate a plurality of input embeddings. Each of the plurality of input embeddings may be specific to one of the at least two search queries. The computer-implemented method 900 may further involve generating the reduced graph from the multi-modal knowledge graph based on the plurality of input embeddings to provide interactive learning using the distilled multimedia data set.

In another form, the computer-implemented method 900 may further involve converting an audio portion of the multimedia data to text and determining semantic relationships in the text. The semantic relationships may include entities and events in the text. The computer-implemented method 900 may further involve generating the multi-modal knowledge graph based on the semantic relationships in which the multimedia data is segmented into the plurality of slices represented by respective nodes in the multi-modal knowledge graph. At least one of the plurality of slices may include a portion of the text, at least one respective semantic relationship, a corresponding audio portion of the multimedia data, and a corresponding video portion of the multimedia data.

According to one or more example embodiments, the computer-implemented method 900 may further involve segmenting a video of the multimedia data into a plurality of video slices to map the entities and the events in the text to the video of the multimedia data.

In one instance, the multimedia data may include one or more of a plurality of network related video learning seminars for configuring one or more network devices in the enterprise network, a plurality of network related video tutorials for obtaining operating data of the one or more network devices in the enterprise network, a plurality of network related videos for progressing a network technology along an adoption lifecycle, and a plurality of troubleshooting videos that address one or more network issues by performing the one or more actions associated with the enterprise network that change a configuration of one or more affected network devices in the enterprise network.

In another instance, in the operation 902, the multimedia data may be obtained from different data sources that provide video recordings associated with the operation or the configuration of the enterprise network.

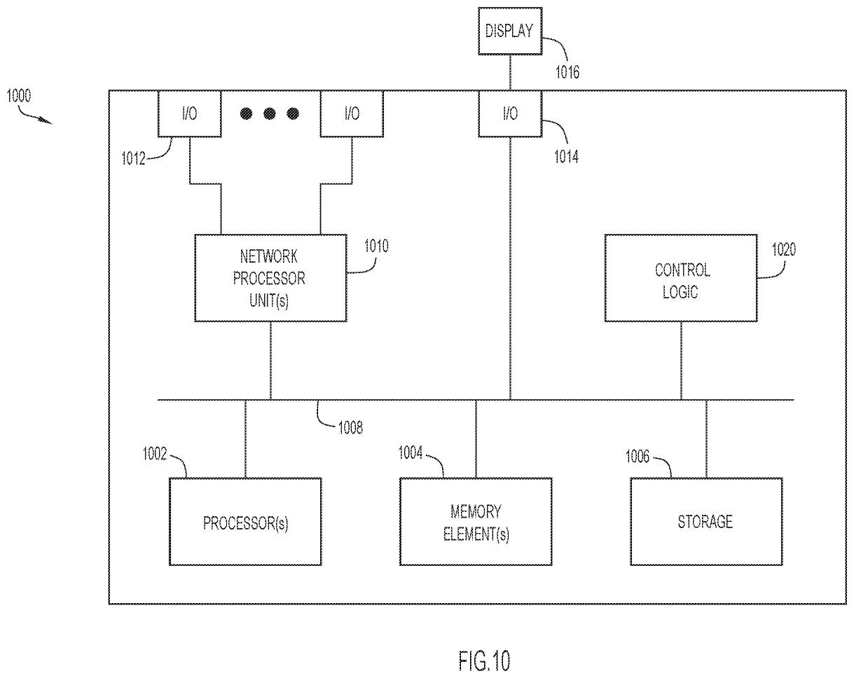

FIG. 10 is a hardware block diagram of a computing device 1000 that may perform functions associated with any combination of operations in connection with the techniques depicted in FIGS. 1-9, according to various example embodiments, including, but not limited to, operations of the computing device or one or more servers that execute the cloud portal 100 and/or the graph based semantic contextualization service 120. Further, the computing device 1000 may be representative of one of the network devices, network/computing equipment, or hardware asset of an enterprise. It should be appreciated that FIG. 10 provides only an illustration of one example embodiment and does not imply any limitations with respect to the environments in which different example embodiments may be implemented. Many modifications to the depicted environment may be made.

In at least one embodiment, computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with one or more memory elements 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, and/or any other I/O port(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 1016 such as a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform a method including obtaining multimedia data from one or more data sources related to operation or configuration of an enterprise network and determining context for generating a distilled multimedia data set based on at least one of user input and user persona. The method further involves generating, based on the context, the distilled multimedia data set including a set of multimedia slices generated from the multimedia data using a multi-modal knowledge graph. The multi-modal knowledge graph is generated using a graph neural network and indicates relationships among a plurality of slices of the multimedia data. The method further involves providing the distilled multimedia data set for performing one or more actions associated with the enterprise network.

In yet another example embodiment, one or more non-transitory computer readable storage media encoded with instructions are provided. When the media is executed by a processor, the instructions cause the processor to execute a method that includes obtaining multimedia data from one or more data sources related to operation or configuration of an enterprise network. The method further involves determining context for generating a distilled multimedia data set based on at least one of user input and user persona and generating, based on the context, the distilled multimedia data set including a set of multimedia slices generated from the multimedia data using a multi-modal knowledge graph. The multi-modal knowledge graph is generated using a graph neural network and indicates relationships among a plurality of slices of the multimedia data. The method further involves providing the distilled multimedia data set for performing one or more actions associated with the enterprise network.

In yet another example embodiment, a system is provided that includes the devices and operations explained above with reference to FIGS. 1-10.

The programs described herein (e.g., control logic 1020) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1006 and/or memory elements(s) 1004 can store data, software, code, instructions (e.g., processor instructions), logic, parameters, combinations thereof, and/or the like used for operations described herein. This includes the storage 1006 and/or memory elements(s) 1004 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining multimedia data from one or more data sources related to operation or configuration of an enterprise network;
determining context for generating a distilled multimedia data set based on at least one of user input and user persona;
generating, based on the context, the distilled multimedia data set comprising a set of multimedia slices generated from the multimedia data using a multi-modal knowledge graph, wherein the multi-modal knowledge graph is generated using a graph neural network and indicates relationships among a plurality of slices of the multimedia data; and
providing the distilled multimedia data set for performing one or more actions associated with the enterprise network.

2. The computer-implemented method of claim 1, wherein the user persona is a network persona, and wherein generating the distilled multimedia data set includes:
generating a reduced graph from the multi-modal knowledge graph based on the network persona and the user input; and
selecting at least two multimedia slices for the distilled multimedia data set using the reduced graph.

3. The computer-implemented method of claim 2, wherein the network persona includes a skill level of a user, and further comprising:
determining the network persona based on past activities performed by the user with respect to the enterprise network.

4. The computer-implemented method of claim 2, wherein the user input includes an actionable task related to the configuration of the enterprise network, and further comprising:
encoding the user input to generate an input embedding; and
generating the reduced graph from the multi-modal knowledge graph based on the input embedding.

5. The computer-implemented method of claim 2, further comprising:
obtaining the user input comprising at least two search queries;
encoding the user input to generate a plurality of input embeddings, each of the plurality of input embeddings being specific to one of the at least two search queries; and
generating the reduced graph from the multi-modal knowledge graph based on the plurality of input embeddings to provide interactive learning using the distilled multimedia data set.

6. The computer-implemented method of claim 1, further comprising:
converting an audio portion of the multimedia data to text;
determining semantic relationships in the text, wherein the semantic relationships include entities and events in the text; and
generating the multi-modal knowledge graph based on the semantic relationships in which the multimedia data is segmented into the plurality of slices represented by respective nodes in the multi-modal knowledge graph, wherein at least one of the plurality of slices includes a portion of the text, at least one respective semantic relationship, a corresponding audio portion of the multimedia data, and a corresponding video portion of the multimedia data.

7. The computer-implemented method of claim 6, further comprising:
segmenting a video of the multimedia data into a plurality of video slices to map the entities and the events in the text to the video of the multimedia data.

8. The computer-implemented method of claim 1, wherein the multimedia data comprises one or more of:
a plurality of network related video learning seminars for configuring one or more network devices in the enterprise network;
a plurality of network related video tutorials for obtaining operating data of the one or more network devices in the enterprise network;
a plurality of network related videos for progressing a network technology along an adoption lifecycle; and
a plurality of troubleshooting videos that address one or more network issues by performing the one or more actions associated with the enterprise network that change the configuration of one or more affected network devices in the enterprise network.

9. The computer-implemented method of claim 1, wherein the multimedia data is obtained from different data sources that provide video recordings associated with the operation or the configuration of the enterprise network.

10. An apparatus comprising:
a memory;
a network interface configured to enable network communications; and
a processor, wherein the processor is configured to perform a method comprising:
obtaining multimedia data from one or more data sources related to operation or configuration of an enterprise network;
determining context for generating a distilled multimedia data set based on at least one of user input and user persona;
generating, based on the context, the distilled multimedia data set comprising a set of multimedia slices generated from the multimedia data using a multi-modal knowledge graph, wherein the multi-modal knowledge graph is generated using a graph neural network and indicates relationships among a plurality of slices of the multimedia data; and
providing the distilled multimedia data set for performing one or more actions associated with the enterprise network.

11. The apparatus of claim 10, wherein the user persona is a network persona, and wherein the processor is configured to generate the distilled multimedia data set by:
generating a reduced graph from the multi-modal knowledge graph based on the network persona and the user input; and
selecting at least two multimedia slices for the distilled multimedia data set using the reduced graph.

12. The apparatus of claim 11, wherein the network persona includes a skill level of a user, and the processor is further configured to perform:
determining the network persona based on past activities performed by the user with respect to the enterprise network.

13. The apparatus of claim 11, wherein the user input includes an actionable task related to the configuration of the enterprise network, and the processor is further configured to perform:
encoding the user input to generate an input embedding; and
generating the reduced graph from the multi-modal knowledge graph based on the input embedding.

14. The apparatus of claim 11, wherein the processor is further configured to perform:
obtaining the user input comprising at least two search queries;
encoding the user input to generate a plurality of input embeddings, each of the plurality of input embeddings being specific to one of the at least two search queries; and
generating the reduced graph from the multi-modal knowledge graph based on the plurality of input embeddings to provide interactive learning using the distilled multimedia data set.

15. The apparatus of claim 10, wherein the processor is further configured to perform:
converting an audio portion of the multimedia data to text;
determining semantic relationships in the text, wherein the semantic relationships include entities and events in the text; and
generating the multi-modal knowledge graph based on the semantic relationships in which the multimedia data is segmented into the plurality of slices represented by respective nodes in the multi-modal knowledge graph, wherein at least one of the plurality of slices includes a portion of the text, at least one respective semantic relationship, a corresponding audio portion of the multimedia data, and a corresponding video portion of the multimedia data.

16. The apparatus of claim 15, wherein the processor is further configured to perform:
segmenting a video of the multimedia data into a plurality of video slices to map the entities and the events in the text to the video of the multimedia data.

17. One or more non-transitory computer readable storage media encoded with software comprising computer executable instructions that, when executed by a processor, cause the processor to perform a method including:
obtaining multimedia data from one or more data sources related to operation or configuration of an enterprise network;
determining context for generating a distilled multimedia data set based on at least one of user input and user persona;
generating, based on the context, the distilled multimedia data set comprising a set of multimedia slices generated from the multimedia data using a multi-modal knowledge graph, wherein the multi-modal knowledge graph is generated using a graph neural network and indicates relationships among a plurality of slices of the multimedia data; and
providing the distilled multimedia data set for performing one or more actions associated with the enterprise network.

18. The one or more non-transitory computer readable storage media according to claim 17, wherein the user persona is a network persona, and the computer executable instructions cause the processor to generate the distilled multimedia data set by:
generating a reduced graph from the multi-modal knowledge graph based on the network persona and the user input; and
selecting at least two multimedia slices for the distilled multimedia data set using the reduced graph.

19. The one or more non-transitory computer readable storage media according to claim 18, wherein the network persona includes a skill level of a user, and the computer executable instructions further cause the processor to perform:
determining the network persona based on past activities performed by the user with respect to the enterprise network.

20. The one or more non-transitory computer readable storage media according to claim 18, wherein the user input includes an actionable task related to the configuration of the enterprise network, and the computer executable instructions cause the processor to perform:
encoding the user input to generate an input embedding; and
generating the reduced graph from the multi-modal knowledge graph based on the input embedding.
